(19) United States
(12) Patent Application Publication
(10) Pub. No.: US 2026/0332585 A1
(43) Pub. Date: Oct. 22, 2026

(54) SYSTEMS AND METHODS FOR BI-DIRECTIONAL VERIFICATION

(71) Applicant: RSA Security USA, LLC, Burlington, MA (US)

(72) Inventors: Michael Sean Miller, Waterloo (CA); Kenn Min Chong, Las Vegas, NV (US); Shane Dominic Rice, Westwood, MA (US); Eric Stewart Leshay, Tewksbury, MA (US)

(73) Assignee: RSA Security USA, LLC, Burlington, MA (US)

(21) Appl. No.: 19/184,276

(22) Filed: Apr. 21, 2025

(51) Int. Cl. H04L 9/40

(52) U.S. Cl. CPC H04L 63/0869; H04L 63/0838; H04L 63/101

(57) ABSTRACT

Systems and methods for bi-directional verification are provided. A method for bi-directional verification includes: a user contacting an administrator, using a zero-trust framework, the administrator authenticating to an administrator account, the administrator triggering a start of a live verification session, determining whether a previous verification session is active for the user, the user navigating to a static uniform resource locator (URL), using the zero-trust framework, the user self-authenticating to generate a request to receive a one-time verification code within the live verification session, when the user does not receive the verification code from the request: the administrator is unverified and no valid live verification session has been created, and when the user receives the verification code from the request to receive the verification code: the administrator is verified, the verified administrator receiving the verification code, and verifying the user within the live verification session using the verification code.

### TECHNICAL FIELD

This disclosure generally relates to systems and methods for bi-directional verification.

### BACKGROUND

Two-factor authentication (2FA), also known as two-step verification or dual-factor authentication, is a security measure in which users provide two distinct authentication factors to verify their identity. The primary purpose of 2FA is to enhance the protection of a user's credentials and the resources they can access. It is commonly used to prevent data breaches and the potential loss of personal information. Compared to single-factor authentication (SFA), which relies solely on one authentication factor like a password or passcode, 2FA offers a higher level of security. In 2FA, the user first provides a password and then a second, different factor, such as a security token or a biometric identifier, such as a fingerprint or facial scan.

By requiring two separate factors, 2FA adds an extra layer of security to the authentication process, making it more difficult for attackers to gain access to a person's devices or online accounts. Even if an attacker manages to obtain the victim's password, it alone is insufficient to pass the authentication check. However, there is still a possibility that a bad actor, e.g., a hacker, a phishing scheme, or an unauthorized person, may pretend to be the administrator and trick the user into providing their information to the bad actor. For example, if a bad actor were pretending to be a helpdesk agent to get information from a user, the user cannot verify the identity of the false agent. Currently, there is no process for bi-directional verification so that the user can verify the administrator and vice versa in the same authentication session.

In addition, with conventional processes, it is difficult to appropriately verify the identity of a user if they have lost or are replacing their primary authentication device, e.g., their mobile device, telephone, or token generator. Shifting the authority to authenticate from one device to another is a place where bad actors can insert themselves. For example, a bad actor may call a call center and pretend that they are the authorized user who claims to have “lost” or “has a new” mobile device phone to try to get the token transferred to a new device that the bad actor controls. Or they might try to phish an authorized user by posing as an agent of the call center to whom someone who actually has lost their phone would need to speak to get the token shifted.

There is therefore a need for establishing trust in the identity of both an administrator and a user during a verification session. Accordingly, there is a need for systems and methods for bi-directional verification.

### SUMMARY

This disclosure pertains to systems and methods for bi-directional verification.

A first aspect of this disclosure pertains to a method for bi-directional verification, including: a user contacting an administrator, using a zero-trust framework, the administrator authenticating to an administrator account, the administrator triggering a start of a live verification session, determining whether a previous verification session is active for the user, the user navigating to a static uniform resource locator (URL) associated with a company associated with the user, using the zero-trust framework, the user self-authenticating at a web page pointed to by the static URL to generate a request to receive a one-time verification code within the live verification session triggered by the authenticated administrator, when the user does not receive the verification code from the request to receive the verification code: determining that the administrator is unverified, and determining that that no valid live verification session has been created, and when the user receives the verification code from the request to receive the verification code: determining that the administrator is verified, the verified administrator receiving the verification code from the user, and verifying the user within the live verification session using the verification code.

A second aspect of this disclosure pertains to the method of the first aspect, and further includes, after the administrator authenticating to an administrator account and before the administrator triggering a start of a live verification session: the administrator searching a list of authorized users to find the user on the list, and the administrator selecting a name on the list as matching the user.

A third aspect of this disclosure pertains to the method of the second aspect, and further includes, before the administrator selecting the name on the list as matching the user, the administrator verbally confirming an identity of the user as matching the name on the list.

A fourth aspect of this disclosure pertains to the method of the first aspect, wherein the user self-authenticating includes using an authenticator application on a mobile device.

A fifth aspect of this disclosure pertains to the method of the first aspect, wherein the static URL points to at least one of: a web page having a Quick Response (QR) code associated with an authenticator application, a multifactor authentication system, a one-time passcode (OTP) authentication system, a FIDO® passkey system, or a biometric authentication system.

A sixth aspect of this disclosure pertains to the method of the fifth aspect, wherein: the QR code has an associated QR timer, and the live verification session ends when the QR timer expires.

A seventh aspect of this disclosure pertains to the method of the first aspect, wherein: the live verification session has an associated session timer, and the live verification session ends when the session timer expires.

An eighth aspect of this disclosure pertains to the method of the first aspect, wherein the user receives the static URL from the administrator verbally.

A ninth aspect of this disclosure pertains to the method of the first aspect, wherein the administrator receives the verification code from the user verbally.

A tenth aspect of this disclosure pertains to the method of the first aspect, wherein the administrator receives the verification code from the user by the user entering the verification code into a prompt.

An eleventh aspect of this disclosure pertains to the method of the first aspect, further including notifying the administrator that the user is verified via a notification on an administrator display.

A twelfth aspect of this disclosure pertains to a system for bi-directional verification, including: a user-side device associated with a user including: one or more user-side processors, and a non-transitory computer-readable medium storing user-side instructions that, when executed, cause the one or more user-side processors to contact an administrator via a communication network, and an administrator-side device associated with an administrator including: one or more administrator processors, and a non-transitory computer-readable medium storing administrator-side instructions that, when executed, cause the one or more administrator-side processors to: use a zero-trust framework for the administrator to authenticate to an administrator account, and trigger a start of a live verification session, determine whether a previous verification session is active for the user, wherein the user navigates to a static uniform resource locator (URL) associated with a company associated with the user, wherein the user-side instructions further cause the system, upon the user using the zero-trust framework to self-authenticate at a web page pointed to by the static URL, to generate a request to receive a one-time verification code within the live verification session triggered by the authenticated administrator, wherein, when the user does not receive the verification code from the request to receive the verification code, the user-side instructions further cause the user-side device to, via the zero-trust network: determine that the administrator is unverified, and determine that that no valid live verification session has been created, wherein, when the user receives the verification code from the request to receive the verification code, the user-side instructions further cause the user-side device to: determine via the system that the administrator is verified, and prompt the user to provide the verification code from the user to the verified administrator, and wherein, when the administrator receives the verification code from the user, the administrator-side instructions further cause the system to verify the user within the live verification session using the verification code.

A thirteenth aspect of this disclosure pertains to the system of the twelfth aspect, wherein, after the administrator authenticating to an administrator account and before the administrator triggering a start of a live verification session, the administrator-side instructions further cause the administrator to be prompted to: search a list of authorized users to find the user on the list, and select a name on the list as matching the user.

A fourteenth aspect of this disclosure pertains to the system of the thirteenth aspect, wherein before the administrator selecting the name on the list as matching the user, the administrator-side instructions further cause the administrator to be prompted to verbally confirm an identity of the user as matching the name on the list.

A fifteenth aspect of this disclosure pertains to the system of the twelfth aspect, and further includes an authenticator application on a mobile device, wherein the user using the zero-trust framework to self-authenticate includes using the authenticator application on the mobile device.

A sixteenth aspect of this disclosure pertains to the system of the twelfth aspect, wherein the static URL points to at least one of: a web page having a Quick Response (QR) code associated with an authenticator application, a multifactor authentication system, a one-time passcode (OTP) authentication system, a FIDO® passkey system, or a biometric authentication system.

A seventeenth aspect of this disclosure pertains to the system of the sixteenth aspect, wherein: the QR code has an associated QR timer, and the live verification session ends when the QR timer expires.

An eighteenth aspect of this disclosure pertains to the system of the twelfth aspect, wherein: the live verification session has an associated session timer, and the live verification session ends when the session timer expires.

A nineteenth aspect of this disclosure pertains to the system of the twelfth aspect, wherein the user receives the static URL from the administrator verbally.

A twentieth aspect of this disclosure pertains to the system of the twelfth aspect, wherein the administrator receives the verification code from the user verbally.

A twenty-first aspect of this disclosure pertains to the system of the twelfth aspect, wherein the administrator receives the verification code from the user by the user entering the verification code into a prompt.

A twenty-second aspect of this disclosure pertains to the system of the twelfth aspect, wherein the administrator-side instructions further cause the administrator to be notified that the user is verified via a notification on an administrator display.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

### BRIEF DESCRIPTION OF DRAWINGS

To describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a flowchart of a workflow for bi-directional verification according to an example embodiment of the present disclosure.

FIG. 2 is a partial screenshot of an administrator prompt screen view according to an example embodiment of the present disclosure.

FIG. 3 is a partial screenshot of an administrator management screen view according to an example embodiment of the present disclosure.

FIG. 4 is a partial screenshot of an administrator verification screen view for a live verification session according to an example embodiment of the present disclosure.

FIG. 5 is a partial screenshot of a user direction screen view for a live verification session according to an example embodiment of the present disclosure.

FIG. 6 illustrates certain components that may be included within a computer system according to an example embodiment of the present disclosure.

FIG. 7 is a partial screenshot of a verification failure screen view for a live verification session according to an example embodiment of the present disclosure.

FIG. 8 is a partial screenshot of a user OTP screen view for a live verification session according to an example embodiment of the present disclosure.

FIG. 9 illustrates certain components that may be included within a computer system according to an example embodiment of the present disclosure.

Before explaining the disclosed embodiment of this disclosure in detail, it is to be understood that the invention is not limited in its application to the details of the particular arrangement shown, as the invention is capable of other embodiments. Example embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

While the subject disclosure applies to embodiments in many different forms, there are shown in the drawings and will be described in detail herein specific embodiments with the understanding that the present disclosure is an example of the principles of the invention. It is not intended to limit the invention to the specific illustrated embodiments. The features of the invention disclosed herein in the description, drawings, and claims can be significant, both individually and in any desired combinations, for the operation of the invention in its various embodiments. Features from one embodiment can be used in other embodiments of the invention. In the description of the drawings, like reference numerals refer to like elements.

As an overview of an example of a bi-directional verification operation, the following steps may be performed:
Step 1: A user contacts an administrator, for example an administrator agent, e.g., for help.
Step 2: Using a zero-trust framework, the administrator must authenticate to an administrator account before triggering the start of a live verification session.
Step 3: Only authenticated administrators can start a live verification session for a user that does not already have an active (or previous) verification session. (This is required to produce a valid verification code in Step 6.)
Step 4: To verify the identity of the user, the user must navigate to a static uniform resource locator (URL) (or link or hyperlink) that is well-known to the user's organization, for example, the link is public or openly available or uses the company's website as the base URL, and the link not a unique one that is only provided by or available through a person purporting to be the administrator.
Step 5: Using zero-trust framework, the user must self-authenticate at a web page (e.g., website) pointed to by the static URL in Step 4 to receive a one-time verification code within the same live verification session triggered by the verified administrator in Step 3.
Step 6: If the user receives a verification code in Step 5, it means that the administrator is verified.
Step 7: If the user does not receive a verification code in Step 5, it means that the administrator is unverified and that no valid live verification session has been created.
Step 8: An administrator that has been verified in Step 3 will receive a verification code from the user, and the system will verify the user within the live verification session that was triggered by the administrator in Step 3.

If the verification code received by the user in Step 6 is valid, then the user is considered to be verified. If the verification code received by the user in Step 6 is invalid, the user is considered to be unverified. The verification code in Step 5 can only be used within the context of the live verification session system, and cannot be used for authentication purposes anywhere else.

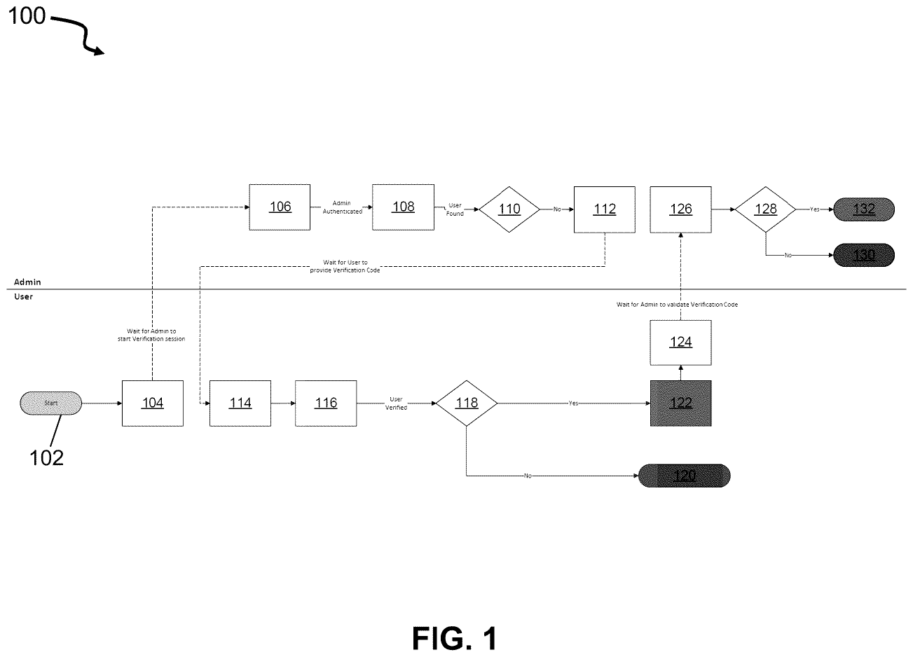

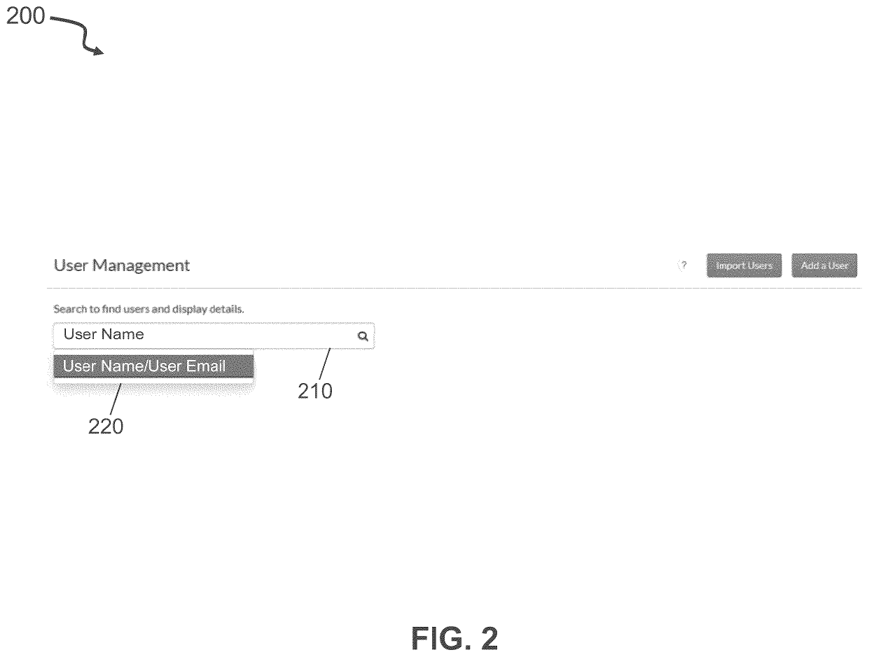

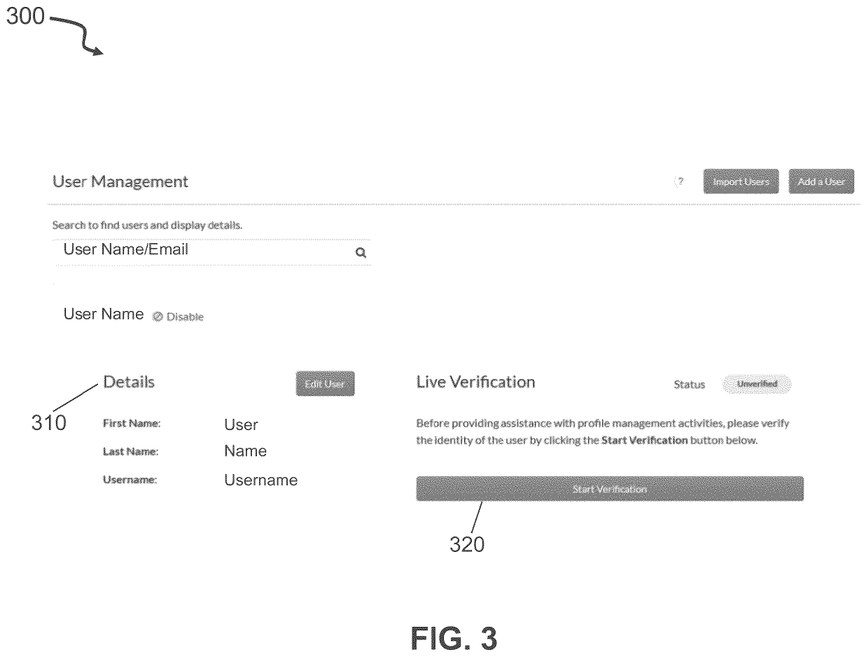

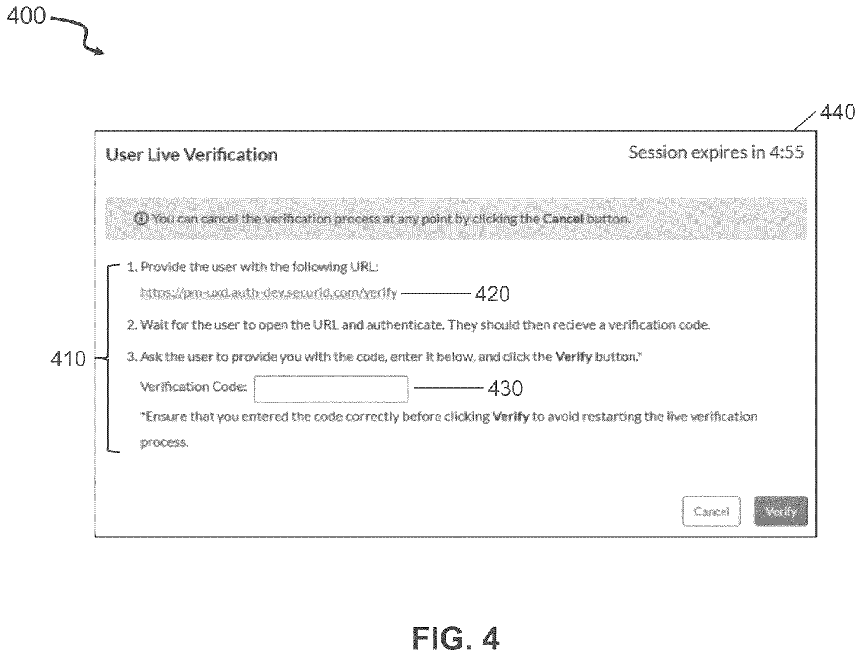

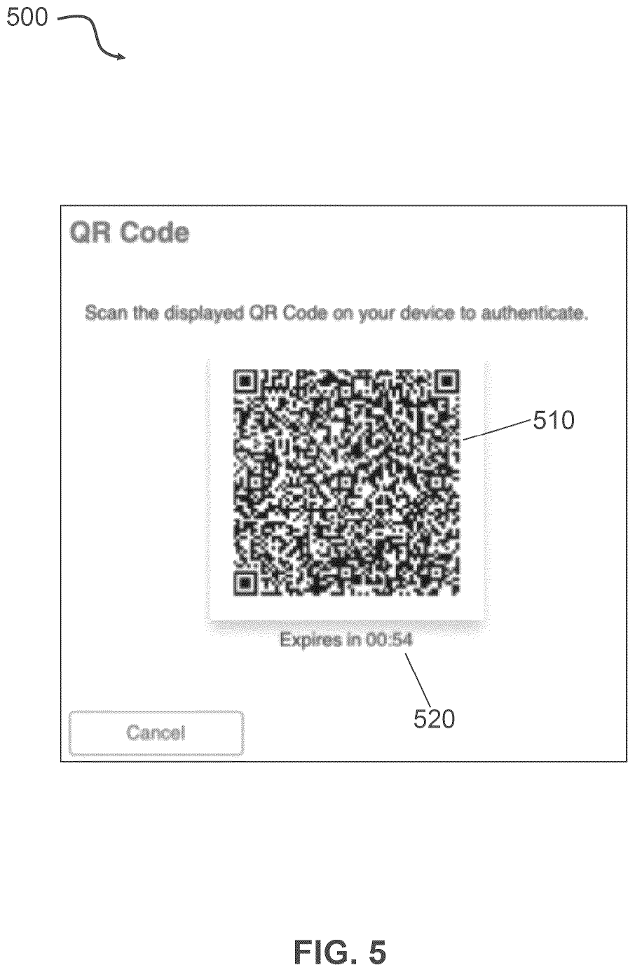

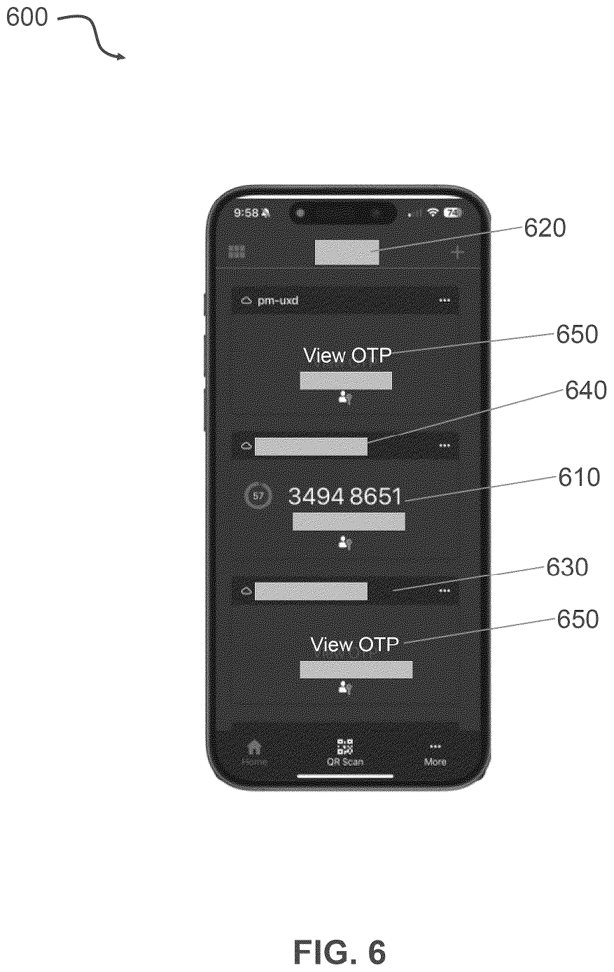

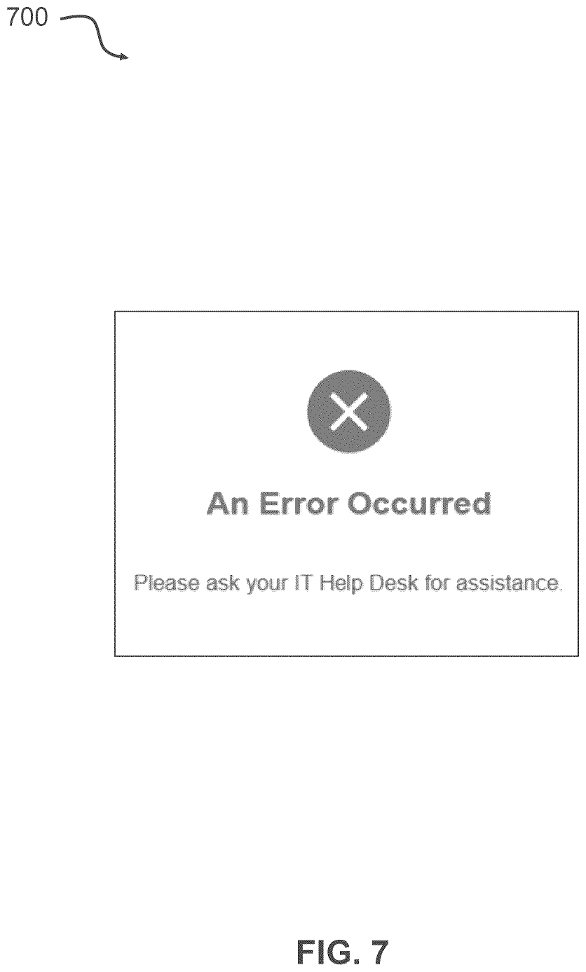

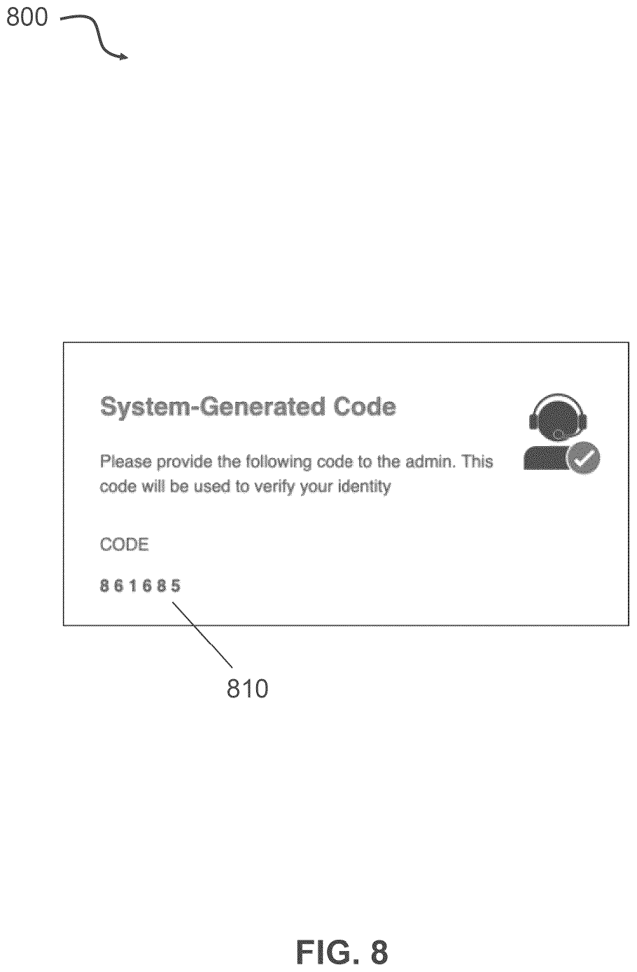

FIG. 1 is a flowchart of a workflow for bi-directional verification according to an example embodiment of the present disclosure. FIG. 2 is a partial screenshot of an administrator prompt screen view according to an example embodiment of the present disclosure. FIG. 3 is a partial screenshot of an administrator management screen view according to an example embodiment of the present disclosure. FIG. 4 is a partial screenshot of an administrator verification screen view for a live verification session according to an example embodiment of the present disclosure. FIG. 5 is a partial screenshot of a user direction screen view for a live verification session according to an example embodiment of the present disclosure. FIG. 6 is a schematic view of a user mobile device authenticator screen view for a live verification session according to an example embodiment of the present disclosure. FIG. 7 is a partial screenshot of a verification failure screen view for a live verification session according to an example embodiment of the present disclosure. FIG. 8 is a partial screenshot of a user OTP screen view for a live verification session according to an example embodiment of the present disclosure.

With reference now to FIGS. 1-8, FIG. 1 illustrates an example workflow 100 for bi-directional verification. The workflow 100 may be divided into administrator-side actions as shown above the center horizontal line with the “Admin” label, and user-side actions as shown below the center horizontal line with the “User” label. User-side actions may be performed on a user device, which may include, for example, one or more processors and a non-transitory computer-readable medium storing user-side instructions that, when executed, cause the one or more user-side processors to perform various functions associated with example embodiments. Similarly, administrator-side actions may be performed on an administrator device, which may include, for example, one or more processors and a non-transitory computer-readable medium storing administrator-side instructions that, when executed, cause the one or more administrator-side processors to perform various functions associated with example embodiments. The user-side device may be any communication device capable of performing the functions of embodiments, and may include, without limitation and interchangeably as appropriate, a mobile device, a mobile phone, a cell phone, an electronic tablet, a computer, a desktop computer, a laptop, a phablet, and/or a terminal. The administrator-side device may be any communication device capable of performing the functions of embodiments, and may include, without limitation and interchangeably as appropriate, a mobile device, a mobile phone, a cell phone, an electronic tablet, a computer, a desktop computer, a laptop, a phablet, and/or a terminal.

At a start 102 at the user end, a user may user a user-side device to initially contact an administrator for help (104), e.g., a helpdesk, for example, over a voice, text, and/or video communication connection, which may include, for example, a computer network, a wireless network, a telephone network, etc. Other nonlimiting examples of the “administrator” may include an agent, a help desk administrator, an agent of the administrator, a user having administrator privileges, etc. Other nonlimiting examples of the “user” may include a client, a caller, an employee, a company employee, etc. The user will then wait for the administrator to start a verification session (“Wait for Admin to start Verification session”). The administrator will receive a request to authenticate the administrator to their administrator account (106), e.g., log into their administrator account on an administrator-side device at their end. Then, once the administrator as been authenticated at their end (“Admin Authenticated”), the administrator can search their system for the user's name as being among a set of authorized users (108). For example, FIG. 2 shows an example of part of an administrator prompt screen 200, e.g., for an administrator display, that may include a search box 210 where the administrator may type the user's name. A list 220 of names of authorized users (e.g., from an employee list of the company hiring the administrator's service) and email addresses matching the typed name may be displayed for selection by the administrator when the administrator finds the user's name. The administrator may confirm the user's name, e.g., by verbally identifying the name on the list, for example, verbally confirming an identity of the user as matching a name on the list. When the user's name is found as being among the set (or list) of authorized users (“User Found”), a check may be made as to whether the user is already in a different verification session (110). If not (“No”), then the administrator may trigger the start of a live user verification session and begin the live verification session (112). For example, FIG. 3 shows an example of part of an administrator management screen view 300 that may show details 310 of the authorized user's information and may have a tool, e.g., a button 320, to initiate the live verification session. For example, FIG. 4 shows an example of an administrator verification screen view 400 for the live verification session, which may include instructions 410 for the administrator to follow, a URL 420 to be provided to the user, and a prompt 430 for a verification code, all of which will be described in detail later. The administrator verification screen view 400 may also include a timer 440 such that the verification session may time out and end after a predetermined amount of time if the verification code is not entered before the timer 440 expires. In the illustrated example, the total time on the timer 440 was originally five minutes (e.g., “5:00”) with five (5) seconds having passed in the example live verification session screenshot (e.g., showing “4:55”). However, embodiments are not limited to five minutes as the total timer expiration time, and the timer 440 itself is optional.

Next, moving to user-side actions, the user may be directed to navigate, e.g., via a web browser, to a static uniform resource locator (URL) or link (e.g., hyperlink), which may be a well-known and/or public URL/link that may lead to a well-known and/or public website/web page. As described herein within the context of a website, the terms “URL,” “link,” and “hyperlink” may be used interchangeably and are not intended to be limiting. In some example embodiments, the administrator may read or spell the website to the user. For example, the website may be under the main URL for the user's employer with a standardized or expected subdirectory or website name, for example, “www.companyname.com/verify” or a similar style of website that is used for all users. Once at the website, the user may be challenged to prove their identity as an authorized user (FIG. 1, 116) for self-authentication. For example, the user may be presented with a Quick Response (QR) code that they can scan using their mobile device, e.g., mobile phone, to verify their identity with an authenticator application on their mobile device. FIG. 5 shows an example of a user direction screen view 500 showing a QR code 510 to be read by the user's mobile device. The user direction screen view 500 may also include a timer 520 such that the QR code 510 may time out and end after a predetermined amount of time if it is not scanned before the timer 520 expires. In the illustrated example, the total time on the timer 440 was originally one minute (e.g., “1:00”) with one (1) second having passed in the example live verification session screenshot (e.g., showing “00:59”). However, embodiments are not limited to one minute as the total timer expiration time, and the timer 520 itself is optional. The user may use, for example, an authenticator application on their mobile device to prove their identity and authorization to be able to access the system (self-authentication), e.g., to verify and/or authenticate the user. For example, a multifactor authentication system, a one-time passcode (OTP) authentication system, a FIDO® passkey system, and/or a biometric authentication system may be used for the self-authentication. Any authenticator device or system may be used for the self-authentication, for example, a mobile authenticator application, a desktop authenticator application, a software authenticator application, and/or a hardware authenticator device, e.g., a token, etc.

FIG. 6 shows a user mobile device authenticator screen view 600 which may include a token code 610, which may be generated by the system, e.g., randomly, by a hash, or by other processes to generate a unique code. Other information, for example, relating to the user and/or the user's company may be viewable on the user mobile device authenticator screen view 600. For example, a company name or logo may be displayed, e.g., at 620. The user's name, username, and/or email address may be displayed, for example, at 630. The user's company URL may be displayed, e.g., at 640. Then, once the user is verified (“User Verified”), e.g., by being able to sign in via their authenticator application on their mobile device, then a check can be performed by the system as to whether the administrator actually triggered the start of the live verification session and whether the live verification session is still valid (FIG. 1, 118), e.g., if the timer 440 has not expired and/or the live verification session has not been canceled. If not (“No” at 118), then the administrator may be considered to be unverified (FIG. 1, 120). In that case, the user will not receive a one-time verification code, e.g., no one-time verification code will be displayed. As such, the user cannot verify the identity of the administrator, and the session workflow may end. FIG. 7 is an example of a verification failure screen view 700 that a user may see if the verification fails at step 118 and the administrator cannot be unverified (120).

However, if at decision step 118 of FIG. 1, the administrator did trigger the start of the verification session and the verification session is still valid (“Yes” at 118), then the administrator is considered to be verified (122). In that case, the user may receive a one-time verification code, e.g., the one-time verification code may be displayed on the user's device or computer. For example, a tool, e.g., a button 650, may be provided in the user mobile device authenticator screen view 600 for the user to select to view a one-time verification code, e.g., a one-time passcode (OTP), for verification to the system for the live authentication session.

When the user selects to view the OTP verification code, they may be presented with a view, e.g., on the web browser, for example, a user OTP screen view 800 with a system-generated OTP code 810, as in the FIG. 8 example. The OTP verification code may be alphanumeric or any symbology that may be input, for example, via a computer keyboard or keypad into a computer prompt, e.g., the prompt 430 of FIG. 4. The OTP verification code should be unique, e.g., with a low probability of accidental duplication among various live verification sessions, and can be used successfully only once per live verification session. Other user identification methods may also be used to verify the user to the administrator in example embodiments. The user may then provide the verification code to the administrator (FIG. 1, 124), e.g., by reading the code out loud to the administrator, for example, via speaking and/or spelling the code verbally, by receiving the code in an electronic communication, e.g., via a messaging system, such as MICROSOFT TEAMS®, SLACK®, email, text message, etc. The administrator may then enter the code into the prompt 430 in the administrator verification screen view 400. In other examples, the user may enter the into a prompt at their end, e.g., in the web browser, which may be, for example provided to the administrator to enter into the prompt 430 or automatically verified by the system.

Referring back to FIG. 1, the system may then wait for the administrator to validate the verification code (“Wait for Admin to validate Verification Code”). Now, returning to administrator-side actions, the administrator may validate the verification code from the user (126). For example, the administrator may enter the verification code into a session prompt at their end, e.g., in a verification session window or screen. The system may then determine whether the verification code and the verification session are still valid (128). If so (“Yes” at 128), then the user may be considered to be verified and the verification session may end (132), and the user and administrator may be considered to be authorized to have continuing communication and/or interaction, for example, to register the verified user's new device for future authentication or engage in other helpdesk functions. In one example, the system may notify the administrator that the user is verified via a notification on an administrator display. For example, a notification may be displayed on the administrator management screen view 300 that the live verification of the user was successful. As such, when the verification code and the verification session are determined to be still valid at 132, then it may be considered that the administrator has been verified to the user, and the user has been verified to the administrator, thus achieving bi-directional verification.

If the verification code and the verification session are not still valid (“No” at 128), then the user may be considered to be unverified and the verification session may end (130). If the administrator or user is unverified and the verification session ends, the user may start a new verification session, e.g., return to start 102. It should be appreciated that FIGS. 2-8 are nonlimiting examples of layout of various screen and device views, e.g., 200, 300, 400, 500, 600, 700, and 800, that may be presented to an administrator and/or a user, and are intended to be explanatory examples only.

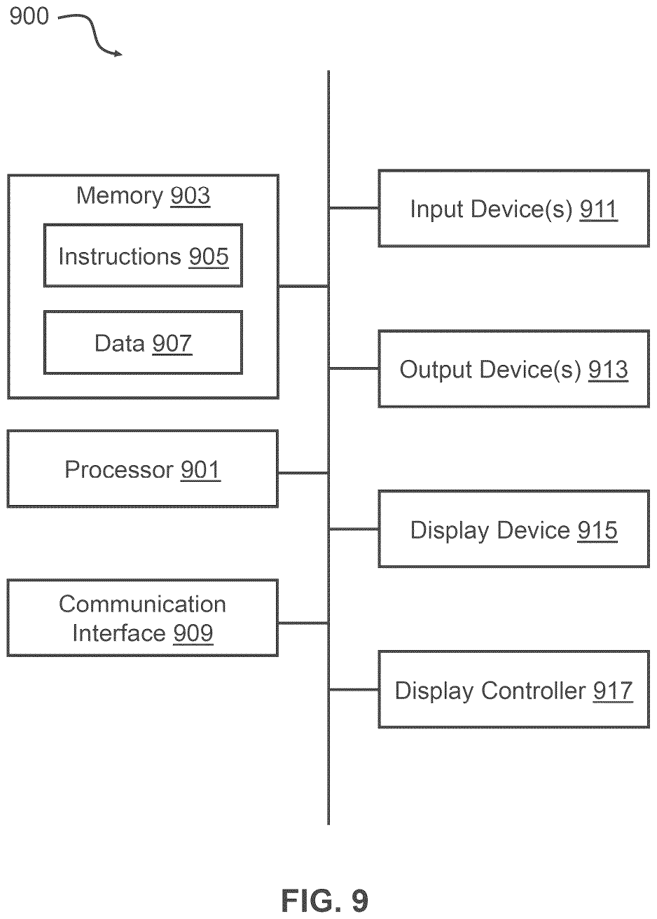

FIG. 9 illustrates certain components that may be included within a computer system according to an example embodiment of the present disclosure.

FIG. 9 illustrates certain components that may be included within a computer system 900, which may be used to control features according to embodiments of the present disclosure, such as the features discussed with reference to FIGS. 1-8. One or more computer systems 900 may be used to implement the various devices, components, and systems described herein. For example, the computer system 900 may be used for either or both of the user-side device and the administrator-side device.

The computer system 900 includes a processor 901. The processor 901 may be a single processor or may include multiple processors and/or sub-processors. The processor 901 may be a general-purpose single-or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used. In one or more embodiments, the computer system 900 further includes one or more graphics processing units (GPUs), which can provide processing services related to both entity classification and graph generation.

The computer system 900 also includes memory 903 in electronic communication with the processor 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

The following are sections in accordance with at least one embodiment of the present disclosure:
Clause 1: A method for bi-directional verification, including: a user contacting an administrator, using a zero-trust framework, the administrator authenticating to an administrator account, the administrator triggering a start of a live verification session, determining whether a previous verification session is active for the user, the user navigating to a static uniform resource locator (URL) associated with a company associated with the user, using the zero-trust framework, the user self-authenticating at a web page pointed to by the static URL to generate a request to receive a one-time verification code within the live verification session triggered by the authenticated administrator, when the user does not receive the verification code from the request to receive the verification code: determining that the administrator is unverified, and determining that that no valid live verification session has been created, and when the user receives the verification code from the request to receive the verification code: determining that the administrator is verified, the verified administrator receiving the verification code from the user, and verifying the user within the live verification session using the verification code.
Clause 2: The method of clause 1, further including, after the administrator authenticating to an administrator account and before the administrator triggering a start of a live verification session: the administrator searching a list of authorized users to find the user on the list, and the administrator selecting a name on the list as matching the user.
Clause 3: The method of clause 2, further including, before the administrator selecting the name on the list as matching the user, the administrator verbally confirming an identity of the user as matching the name on the list.
Clause 4: The method of clause 1, wherein the user self-authenticating includes using an authenticator application on a mobile device.
Clause 5: The method of clause 1, wherein the static URL points to at least one of: a web page having a Quick Response (QR) code associated with an authenticator application, a multifactor authentication system, a one-time passcode (OTP) authentication system, a FIDO® passkey system, or a biometric authentication system.
Clause 6: The method of clause 5, wherein: the QR code has an associated QR timer, and the live verification session ends when the QR timer expires.
Clause 7: The method of clause 1, wherein: the live verification session has an associated session timer, and the live verification session ends when the session timer expires.
Clause 8: The method of clause 1, wherein the user receives the static URL from the administrator verbally.
Clause 9: The method of clause 1, wherein the administrator receives the verification code from the user verbally.
Clause 10: The method of clause 1, wherein the administrator receives the verification code from the user by the user entering the verification code into a prompt.
Clause 11: The method of clause 1, further including notifying the administrator that the user is verified via a notification on an administrator display.
Clause 12: A system for bi-directional verification, including: a user-side device associated with a user including: one or more user-side processors, and a non-transitory computer-readable medium storing user-side instructions that, when executed, cause the one or more user-side processors to contact an administrator via a communication network, and an administrator-side device associated with an administrator including: one or more administrator processors, and a non-transitory computer-readable medium storing administrator-side instructions that, when executed, cause the one or more administrator-side processors to: use a zero-trust framework for the administrator to authenticate to an administrator account, and trigger a start of a live verification session, determine whether a previous verification session is active for the user, wherein the user navigates to a static uniform resource locator (URL) associated with a company associated with the user, wherein the user-side instructions further cause the system, upon the user using the zero-trust framework to self-authenticate at a web page pointed to by the static URL, to generate a request to receive a one-time verification code within the live verification session triggered by the authenticated administrator, wherein, when the user does not receive the verification code from the request to receive the verification code, the user-side instructions further cause the user-side device to, via the zero-trust network: determine that the administrator is unverified, and determine that that no valid live verification session has been created, wherein, when the user receives the verification code from the request to receive the verification code, the user-side instructions further cause the user-side device to: determine via the system that the administrator is verified, and prompt the user to provide the verification code from the user to the verified administrator, and wherein, when the administrator receives the verification code from the user, the administrator-side instructions further cause the system to verify the user within the live verification session using the verification code.
Clause 13: The system of clause 12, wherein, after the administrator authenticating to an administrator account and before the administrator triggering a start of a live verification session, the administrator-side instructions further cause the administrator to be prompted to: search a list of authorized users to find the user on the list, and select a name on the list as matching the user.
Clause 14: The system of clause 13, wherein, before the administrator selecting the name on the list as matching the user, the administrator-side instructions further cause the administrator to be prompted to verbally confirm an identity of the user as matching the name on the list.
Clause 15: The system of clause 12, further including: an authenticator application on a mobile device, wherein the user using the zero-trust framework to self-authenticate includes using the authenticator application on the mobile device.
Clause 16: The system of clause 12, wherein the static URL points to at least one of: a web page having a Quick Response (QR) code associated with an authenticator application, a multifactor authentication system, a one-time passcode (OTP) authentication system, a FIDO® passkey system, or a biometric authentication system.
Clause 17: The system of clause 16, wherein: the QR code has an associated QR timer, and the live verification session ends when the QR timer expires.
Clause 18: The system of clause 12, wherein: the live verification session has an associated session timer, and the live verification session ends when the session timer expires.
Clause 19: The system of clause 12, wherein the user receives the static URL from the administrator verbally.
Clause 20: The system of clause 12, wherein the administrator receives the verification code from the user verbally.
Clause 21: The system of clause 12, wherein the administrator receives the verification code from the user by the user entering the verification code into a prompt.
Clause 22: The system of clause 12, wherein the administrator-side instructions further cause the administrator to be notified that the user is verified via a notification on an administrator display.

Systems and software, e.g., implemented on a non-transitory computer-readable medium, for performing the methods discussed herein are also within the scope of embodiments of the present disclosure.

Embodiments of the present disclosure may thus utilize a special purpose or general-purpose computing system including computer hardware, such as, for example, one or more processors and system memory. Embodiments within the scope of the present disclosure also include physical and other computer-readable media for carrying or storing computer-executable instructions and/or data structures, including applications, tables, data, libraries, or other modules used to execute particular functions or direct selection or execution of other modules. Such computer-readable media can be any available media that can be accessed by a general purpose or special purpose computer system. Computer-readable media that store computer-executable instructions (or software instructions) are physical storage media. Computer-readable media that carry computer-executable instructions are transmission media. Thus, by way of example, and not limitation, embodiments of the present disclosure can include at least two distinctly different kinds of computer-readable media, namely physical storage media or transmission media. Combinations of physical storage media and transmission media should also be included within the scope of computer-readable media.

Both physical storage media and transmission media may be used temporarily store or carry, software instructions in the form of computer readable program code that allows performance of embodiments of the present disclosure. Physical storage media may further be used to persistently or permanently store such software instructions. Examples of physical storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored as or in software, hardware, firmware, or combinations thereof.

A “network” or “communications network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instructions or data structures and which can be accessed by a general purpose or special purpose computer.

Further, upon reaching various computer system components, program code in the form of computer-executable instructions or data structures can be transferred automatically or manually from transmission media to physical storage media (or vice versa). For example, computer-executable instructions or data structures received over a network or data link can be buffered in memory (e.g., RAM) within a network interface module (NIC), and then eventually transferred to computer system RAM and/or to less volatile physical storage media at a computer system. Thus, it should be understood that physical storage media can be included in computer system components that also (or even primarily) utilize transmission media.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure. Any trademark referenced herein is the respective property of its owner.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

1. A method for bi-directional verification, comprising:
a user contacting an administrator;
using a zero-trust framework, the administrator authenticating to an administrator account;
the administrator triggering a start of a live verification session;
determining whether a previous verification session is active for the user;
the user navigating to a static uniform resource locator (URL) associated with a company associated with the user;
using the zero-trust framework, the user self-authenticating at a web page pointed to by the static URL to generate a request to receive a one-time verification code within the live verification session triggered by the authenticated administrator;
when the user does not receive the verification code from the request to receive the verification code:
determining that the administrator is unverified; and
determining that that no valid live verification session has been created; and
when the user receives the verification code from the request to receive the verification code:
determining that the administrator is verified;
the verified administrator receiving the verification code from the user; and
verifying the user within the live verification session using the verification code.

2. The method of claim 1, further comprising, after the administrator authenticating to an administrator account and before the administrator triggering a start of a live verification session:
the administrator searching a list of authorized users to find the user on the list; and
the administrator selecting a name on the list as matching the user.

3. The method of claim 2, further comprising, before the administrator selecting the name on the list as matching the user, the administrator verbally confirming an identity of the user as matching the name on the list.

4. The method of claim 1, wherein the user self-authenticating comprises using an authenticator application on a mobile device.

5. The method of claim 1, wherein the static URL points to at least one of: a web page having a Quick Response (QR) code associated with an authenticator application, a multifactor authentication system, a one-time passcode (OTP) authentication system, a FIDO® passkey system, or a biometric authentication system.

6. The method of claim 5, wherein:
the QR code has an associated QR timer; and
the live verification session ends when the QR timer expires.

7. The method of claim 1, wherein:
the live verification session has an associated session timer; and
the live verification session ends when the session timer expires.

8. The method of claim 1, wherein the user receives the static URL from the administrator verbally.

9. The method of claim 1, wherein the administrator receives the verification code from the user verbally.

10. The method of claim 1, wherein the administrator receives the verification code from the user by the user entering the verification code into a prompt.

11. The method of claim 1, further comprising notifying the administrator that the user is verified via a notification on an administrator display.

12. A system for bi-directional verification, comprising:
a user-side device associated with a user comprising:
one or more user-side processors; and
a non-transitory computer-readable medium storing user-side instructions that, when executed, cause the one or more user-side processors to contact an administrator via a communication network; and
an administrator-side device associated with an administrator comprising:
one or more administrator processors; and
a non-transitory computer-readable medium storing administrator-side instructions that, when executed, cause the one or more administrator-side processors to:
use a zero-trust framework for the administrator to authenticate to an administrator account; and
trigger a start of a live verification session,
determine whether a previous verification session is active for the user,
wherein the user navigates to a static uniform resource locator (URL) associated with a company associated with the user,
wherein the user-side instructions further cause the system, upon the user using the zero-trust framework to self-authenticate at a web page pointed to by the static URL, to generate a request to receive a one-time verification code within the live verification session triggered by the authenticated administrator,
wherein, when the user does not receive the verification code from the request to receive the verification code, the user-side instructions further cause the user-side device to, via the zero-trust network:
determine that the administrator is unverified, and
determine that that no valid live verification session has been created,
wherein, when the user receives the verification code from the request to receive the verification code, the user-side instructions further cause the user-side device to:
determine via the system that the administrator is verified, and
prompt the user to provide the verification code from the user to the verified administrator, and
wherein, when the administrator receives the verification code from the user, the administrator-side instructions further cause the system to verify the user within the live verification session using the verification code.

13. The system of claim 12, wherein, after the administrator authenticating to an administrator account and before the administrator triggering a start of a live verification session, the administrator-side instructions further cause the administrator to be prompted to:
search a list of authorized users to find the user on the list; and
select a name on the list as matching the user.

14. The system of claim 13, wherein, before the administrator selecting the name on the list as matching the user, the administrator-side instructions further cause the administrator to be prompted to verbally confirm an identity of the user as matching the name on the list.

15. The system of claim 12, further comprising:
an authenticator application on a mobile device,
wherein the user using the zero-trust framework to self-authenticate comprises using the authenticator application on the mobile device.

16. The system of claim 12, wherein the static URL points to at least one of: a web page having a Quick Response (QR) code associated with an authenticator application, a multifactor authentication system, a one-time passcode (OTP) authentication system, a FIDO® passkey system, or a biometric authentication system.

17. The system of claim 16, wherein:
the QR code has an associated QR timer; and
the live verification session ends when the QR timer expires.

18. The system of claim 12, wherein:
the live verification session has an associated session timer; and
the live verification session ends when the session timer expires.

19. The system of claim 12, wherein the user receives the static URL from the administrator verbally.

20. The system of claim 12, wherein the administrator receives the verification code from the user verbally.

21. The system of claim 12, wherein the administrator receives the verification code from the user by the user entering the verification code into a prompt.

22. The system of claim 12, wherein the administrator-side instructions further cause the administrator to be notified that the user is verified via a notification on an administrator display.
